(19) United States
(12) Patent Application Publication
(10) Pub. No.: US 2006/0007610 A1
(43) Pub. Date: Jan. 12, 2006

(54) Leakage current detector interrupter with reset lockout

(76) Inventors: David Y. Chan, Bellerose, NY (US); Roger M. Bradley, North Bellmore, NY (US); James Richter, Bethpage, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/088,754

(22) Filed: Mar. 25, 2005

Related U.S. Application Data
(60) Provisional application No. 60/558,954, filed on Apr. 2, 2004.

(51) Int. Cl. H02H 3/00

(52) U.S. Cl. 361/42

(57) ABSTRACT

An electrical extension cord includes a leakage current detector interrupter (LCDI) with reset lockout that can interrupt the power being supplied a line side of the cord to a corded appliance or to household wiring when a leakage current is detected flowing from any of the wires in the load side of the cord to a shield within the cord. The LCDI may be enclosed in a housing on a plug end of the cord that includes the plug for connection to the line.

This application claims the benefit of the filing date of a provisional application having Ser. No. 60/558,954 which was filed on Apr. 2, 2004.

### BACKGROUND OF THE INVENTION

1. Field of the Invention

This invention relates generally to leakage current detector interrupters.

2. Description of the Prior Art

A type of electrical extension cord which can provide ground fault protection can include a ground fault circuit interrupter (GFCI). A GFCI is a device that may use a trip mechanism to disconnect line conductors from load conductors when an electrical fault such as excessive leakage current to ground occurs. GFCI devices are normally resettable, that is, placed in a condition to detect another occurrence of a ground fault, after they are tripped by, for example, the detection of a first ground fault. Trip mechanisms which cause the mechanical breaking of the circuit (i.e., the connection between input and output conductors) include a solenoid (or trip coil). A test button can be used to test the trip mechanism and circuitry used to sense faults and a reset button can be used to reset the electrical connection between input and output conductors.

However, instances may arise where an abnormal condition, caused by, for example, a lightening strike, occurs which may result not only in a surge of electricity which causes a tripping of the device, but also may cause a disabling of the trip mechanism and/or circuitry used to sense faults which cause the breaking of the circuit. That is, the device may have become inoperable with respect to breaking the connection between the input and the output conductors when a fault occurs. This may occur without the knowledge of the user. Under such circumstances an unknowing user, faced with a GFCI which has tripped, may press the reset button which, in turn, may cause the device with an inoperative trip mechanism and/or inoperative circuitry to be reset without the ground fault protection being available.

Also, an open neutral condition may exist with the electrical wires supplying electrical power to such GFCI devices. If such an open neutral condition exists with the neutral wire on the Line (as opposed to Load) side of the GFCI device, an instance may arise where a current path may be created from the phase (or hot) wire supplying power to the GFCI device through the load side of the device and, possibly, through a person to ground. That is, electrical power that would normally flow through the phase wire and load back to the neutral could, in the fault condition, return to ground through a person. This condition presents a potential shock hazard.

Electrical extension cords or corded electrical appliances can have conductors to carry current from an input or Line side to an output or Load side. The input power can have conductors including a Line Phase, Line Neutral and ground. The cord can have corresponding conductors including a Load Phase, Load Neutral and ground. The Load cord also may include a shield surrounding the conductors. Through usage or age, the insulation of electrical cords may degrade or become damaged which can result in leakage currents not only to ground but between the conductors or a conductor and the shield. Degradation and damage of the insulation also may result in arcing between the conductors and/or a conductor and the shield.

In an electrical circuit, including in residences and commercial locations, electrical current can flow from the Line Phase through the electrical appliance and return to the Line Neutral. In normal usage, current does not flow from a Load Phase conductor to the shield. Flow of current from the Load Phase to the shield can present a hazardous shock condition. A leakage current detector interrupter (LCDI) is a device that senses leakage current flowing between or from the attached cord conductors and interrupts the circuit at a predetermined level of leakage current. Because a LCDI can detect a current leakage flowing to ground, it can provide ground fault protection in addition to protection from arcing and other problems which may arise due to leakage between conductors, between a conductor and a shield or a conductor and ground.

### SUMMARY OF THE DISCLOSURE

The disclosure includes techniques for a leakage current detector interrupter (LCDI), which may include a reset lockout, that can interrupt the power being supplied to an extension cord or a corded appliance when a leakage current is detected flowing from any of the wires in the load side cord to a shield within the cord. The leakage current may be caused by degradation of the insulation around the wires due to arcing, fire, overheating, or physical or chemical abuse.

### BRIEF DESCRIPTION OF THE DRAWINGS

Features and advantages of the present invention will be more readily understood upon consideration of the following detailed description of a preferred embodiment of the invention when taken in conjunction with the following drawings wherein like parts are represented by similar reference numbers.

FIG. 1 is a schematic drawing of an implementation of the disclosed leakage current detector interrupter in an electrical extension cord.

FIG. 2 is a front elevation view of the face of a plug of the extension cord of FIG. 1.

FIG. 3 is a front elevation view of the face of the receptacle of the extension cord of FIG. 1.

FIG. 4 is a schematic of the circuit diagram of a leakage current detector.

### DETAILED DESCRIPTION

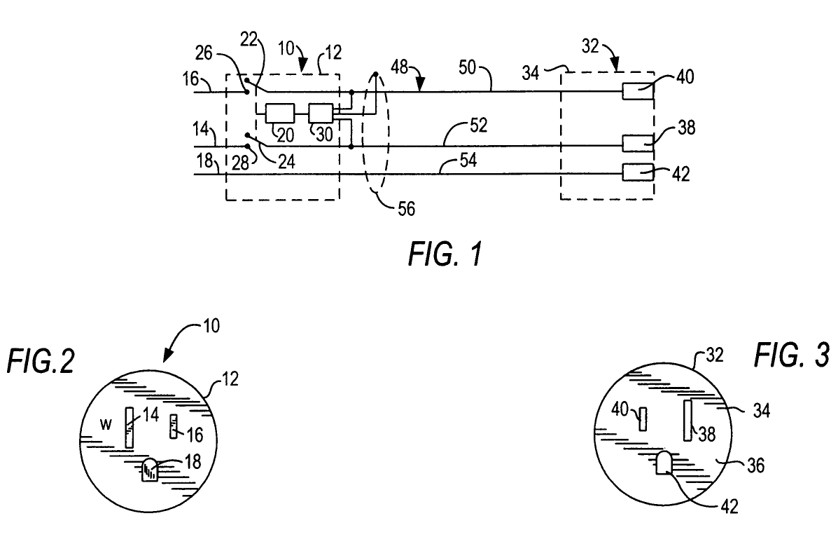

FIGS. 1, 2 and 3 illustrate an implementation of an electrical extension cord constructed in accordance with the principles of the invention. Plug 10 has a housing 12 from which project flat plug blades 14 and 16 and a curved ground blade 18. The phase blade 16 is smaller than the neutral blade 14 as is the usual industry practice. Further, within the housing 12 a solenoid operated relay 20 may be disposed and coupled to movable contact 22 for the line phase and to movable contact 24 for the line neutral. The position of movable contacts 22, 24, respectively, in FIG. 1 are in the open position which opens both the phase and neutral conductors. When the solenoid operated relay 20 no longer receives an operating signal, the movable contacts 22 and 24 can engage fixed contacts 26 and 28 and complete the phase and neutral conductors and current can flow to the receptacle 32 or load side of the electrical cord. A control device 30 may be coupled to solenoid operated relay 20 to operate it in accordance with the detection of leakage current in the electrical cord such as may result from arcing or degradation of the cord.

On the load side of the electrical cord can be a receptacle 32 including a housing 34 having a front face 36 in which are placed blade passageways. Passageway 38 can receive the neutral conductor, passageway 40 can receive the phase conductor and passageway 42 can receive the ground conductor. Behind the blade passageways through the front face 36 may be chambers in which the contacts are placed. The contacts (not shown) can engage the flat plug blades 14 and 16 and the curved ground blade 18 and make electrical and mechanical contact between the conductors of the extension cord and the load (not shown) plugged into receptacle 32.

The electrical cord 48, which joins plug 10 to receptacle 32, can include a phase conductor 50 to connect movable contact 22 and plug blade 16 to the contact (not shown) in passageway 40; a neutral conductor 52 to connect plug blade 14 and movable contact 24 through fixed contact 26 to the contact (not shown) in passageway 38; and a ground conductor 54 to connect the curved ground blade 18 to the contact (not shown) in passageway 42. In some implementations, the electrical cord may include a conductive shield 56 that may surround one or more of the phase, neutral and ground wires. In another implementation, the disclosed electrical cord protection may be used where the cord terminates in an electrical appliance rather than a receptacle 32.

The control device 30 may be coupled to phase, neutral and shield on the load side of the electrical cord. The control device 30 can monitor leakage currents among the phase, neutral and shield. The control device 30 can actuate the solenoid controlled relay 20 to open the connection between the line phase 16 and line neutral 14 and the corresponding load side conductors when the leakage current exceed a predetermined level. In an implementation, the control device can be a leakage current detector that can detect arcing currents in the electrical cord.

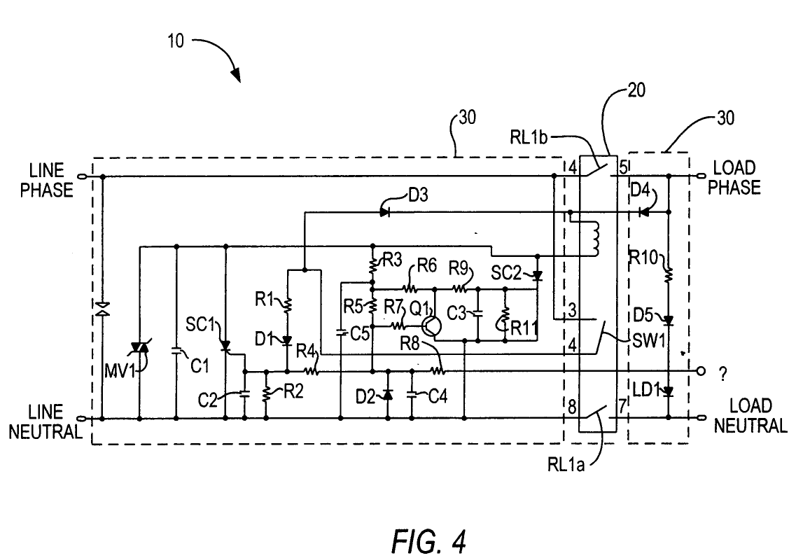

FIG. 4 illustrates a schematic of an implementation of the leakage current detector interrupter (LCDI) that can be contained within a plug that can be plugged into a receptacle, which provides electrical power. In an implementation, the electrical power is 120 volts alternating current (VAC), which is household line current. The electrical power may have two conductors indicated as Line Phase and Line Neutral. The LCDI can provide electrical power to an electrical cord having conductors Load Phase and Load Neutral corresponding to the Line Phase and Line Neutral, respectively. A double-poled relay 20, capable of disconnecting power to Load Phase and Load Neutral upon the detection of leakage current. The relay 20 can be latched mechanically and tripped by a solenoid (20, pins 1 and 2) The solenoid may be of the discontinuous type so that the solenoid is actuated only when required to move the catchment that can moves the relay contacts RL1a, RL1b.

A ground wire also may be present with a hardwired connection from Line to Load side. The ground may not disconnected upon detection of leakage current. An indicator LD1 on the load side of the device can be included to indicate whether power is connected to the load. When the contacts RL1a, Rl1b are closed, Line power is connected to the load. The load side power can be rectified by diode D5 and used to illuminate indicator LD1. A resistor R10 can be included to limit current through the indicator LD1. When the contacts RL1a, RL1b are open, such as after the LCDI is tripped, the Line power is disconnected from the load power and the indicator LD1 is extinguished.

With the device plugged in input power is connected to Line Phase and Load Phase, the LCDI may be in the tripped state. Relay coil 200 is de-energized with the contacts RL1a, RL1b open) and Line Phase and Line Neutral are disconnected from Load Phase and Load Neutral, respectively. Upon pressing reset button (not shown) to mechanically reset the relay, the catchment, which closes the contacts, may be blocked and the lockout switch SW1 (20, pins 3 and 4) is closed instead. With SW1 closed, Line power can be provided to the solenoid coil 200 (20, pins 1 and 2) of the relay 20 through diode D3. Simultaneously, voltage is applied to a gate of a silicon-controlled rectifier (SCR) SC1 through current limiting resistor R1 and rectifying diode D1. Resistors R1, R2 form a voltage divider to establish a voltage on the first gate of the SCR SC1. The voltage at the gate is sufficient to trigger the SCR SC1, which starts to conduct current from anode to cathode. Thus, a current path is established from the input power, through the path switch SW1, diode D3, relay coil 200, SCR SC1 and then return to Line Neutral. The reset button can engage the catchment and close the relay contacts. However, if the solenoid cannot be energized, then the reset button is locked out. The button can not engage the catchment and power is not supplied to the load. Thus, if the LCDI is functional, then the device can be reset to having relay contacts RL1a, RL1b closed because the trigger circuit of SCR SC1 is working.

Once the contacts RL1a, RL1b are closed, switch SW1 may be opened. Power for the circuit can be supplied from the Load Phase through a blocking diode D4 and the solenoid coil 200. Diode D4 and C1 provide a half-wave rectified voltage supply to power the electronics. A metal-oxide varistor (MOV) MV1 can be included to provide protection from destructive voltage spikes on the line side of the cord.

When in operation, the circuit may be triggered to remove power to the load side when a current fault is detected. One or more SCR's, depending on the fault type, may be triggered and energize the relay coil 200. The illustrated implementation includes two SCRs (SC1 and SC2) either of which may be triggered and, in turn, energize the coil 200 and cause actuation of the solenoid and open the contacts RL1a, RL1b to remove power from the load side of the electrical cord.

SCR SC1 can be triggered when current leakage is detected from Load Phase to a Shield incorporated into the load side of the cord. Leakage current that flows from the Load Phase through the Shield can flow through resistors R8, R4 and R2 to Load Neutral. The gate of SC1 is connected between resistors R4 and R2. SCR SC1 can trigger, thus conduting current from cathode to anode, when a threshold voltage and current is provided to the gate of SCR SC1. The threshold may be exceeded when the leakage current to the Shield increases. When SCR SC1 triggers, the relay coil 200 can be energized by current that can now flow through the relay coil 200 and through the SCR SC1 to Line Neutral. Energizing relay coil 200, in turn, opens relay contacts RL1a, RL1b, which removes power from the load side. Capacitors C2, C4 may be added to reduce false tripping by filtering electrical noise on the shield. A diode D2 can be added to discharge the capacitors C2, C4 during the half cycle when line neutral is positive with respect to the line phase to reduce electrical charge from accumulating on the capacitors and, thus, reduce false triggering of the SCR SC1. In an embodiment, the resistors R8, R4 and R2 and the gate sensitivity of SCR SC1 are selected to trigger the SCR SC1 at or above a leakage current of approximately 4 milliamps (mA)±1 mA over a large temperature range.

SCR SC2 can be triggered when current leakage current is detected from Load Neutral or Ground to the Shield. The circuit operation does not depend on a Grounded conductor in the cord. Ground may connected to Line Neutral at the service entrance panel. In the illustrated implementation, resistors R3, R5, R4 and R2 create a voltage divider from the Load Phase power, which is rectified by diode D4 and smoothed by capacitor C1. As described above, the voltage level between resistors R4 and R2 may not be great enough to trigger SCR SC1. However, the voltage between R5 and R4 can be sufficient to turn on transistor Q1 through resistor R7. When transistor Q1 is on, it pulls down the voltage level at the junction between resistors R6 and R9 towards the level of Line Neutral. This voltage level can be further divided by resistors R9, R11, which may be selected to prevent SCR SC2 from being triggered. However, when leakage current flows between the Shield and Load Neutral or the Shield and Ground, then the voltage level at the connection between resistors R5 and R4 is pulled down towards the level of Line Neutral because the leakage current causes an increase in the voltage drop across resistor R8. Thus, the voltage level between resistors R4 and R5 can depend on the level of leakage current that may be flowing between Shield and Load Neutral and/or between the Shield and Ground. When the leakage current between Shield and Load Neutral and/or between the Shield and Ground is sufficiently high, the voltage level at the junction of resistors R4 and R5 can be reduced to a level where transistor Q1 turns off. When transistor Q1 is off the voltage level at the junction between resistors R6 and R9 can rise and trigger SCR SC2, which, in turns, energizes the relay coil 200 and opens the relay contacts RL1a and RL1b to disconnect the load side of the cord. In the implementation illustrated, capacitors C5 and C3 (and C4) may be included to provide noise filtering for transistor Q1 and SCR SC2.

While there have been shown and described and pointed out the fundamental features of the invention as applied to the preferred embodiment, as is presently contemplated for carrying them out, it will be understood that various omissions and substitutions and changes in the form and details of the device described and illustrated and in its operation may be made by those skilled in the art, without departing from the spirit of the invention.

What is claimed is:

1. An electrical circuit interrupter comprising:
an electrical extension cord having line conductors and corresponding load conductors;
a leakage current detector coupled to the line and load conductors to provide an interrupt signal in response to detection of a leakage current in the load conductors; and
a circuit interrupter to break an electrical connection between line conductors and load conductors in response to receipt of the interrupt signal.

2. The electrical circuit interrupter of claim 1 comprising:
a reset lock-out responsive to the occurrence of the interrupt signal such that the reset lock-out is operable between a lock-out position wherein the reset lock-out inhibits resetting of the electrical connection between the line and load conductors and a reset position wherein the reset lock-out does not inhibit resetting of the electrical connection between the line and load conductors; and
a reset mechanism operatively associated with the reset lock-out and the circuit interrupter such that activation of the reset mechanism activates the circuit interrupter which facilitates movement of the reset lock-out from the lock-out position to the reset position by the reset mechanism.

3. The electrical circuit interrupter of claim 2 comprising a shield around the load conductors, wherein the leakage current detector provides the interrupt signal in response to a leakage current between a load conductor and the shield.

4. An electrical circuit interrupter comprising:
a housing having electrical plug blades;
an electrical extension cord having line conductors and corresponding load conductors, the line conductors coupled to respective plug blades;
a leakage current detector in the housing to provide an interrupt signal in response to detection of a leakage current in the load conductors; and
a circuit interrupter to break an electrical connection between line conductors and load conductors in response to receipt of the interrupt signal.

5. The electrical circuit interrupter of claim 3 comprising an electrical socket having receptacles coupled to respective line conductors.

6. The electrical circuit interrupter of claim 5 comprising a shield around the load conductors, wherein the leakage current detector provides the interrupt signal in response to a leakage current between a load conductor and the shield.

7. The electrical circuit interrupter of claim 3 comprising:
a reset lock-out responsive to the occurrence of the interrupt signal such that the reset lock-out is operable between a lock-out position wherein the reset lock-out inhibits resetting of the electrical connection between the line and load conductors and a reset position wherein the reset lock-out does not inhibit resetting of the electrical connection between the line and load conductors; and
a reset mechanism operatively associated with the reset lock-out and the circuit interrupter such that activation of the reset mechanism activates the circuit interrupter which facilitates movement of the reset lock-out from the lock-out position to the reset position by the reset mechanism.

8. An electrical circuit interrupter comprising
a leakage current detector with reset lockout and operative to supply an interrupt signal in response to detecting a leakage current in a load conductor of an electrical extension cord;
a relay coupled to the leakage current detector and having contacts to couple the line conductors to the load conductors;
latch means coupled to the relay to latch the relay in a desired state; and
a solenoid coupled to selectively operate the relay to interrupt electrical connection between a line conductor and the load conductor in response to the interrupt signal.

9. The electrical circuit interrupter of claim 8 comprising a shield around the load conductors, wherein the leakage current detector provides the interrupt signal in response to a leakage current between a load conductor and the shield or between load conductors.

10. The electrical circuit interrupter of claim 8, wherein the latch means includes a silicon controlled rectifier.

11. An electrical extension cord including built-in safety protection, comprising:
an electrical cord including separately insulated phase, neutral, and shield conductors;
an electrical receptacle electrically connected to the electrical cord at first ends of the phase and neutral conductors and having three blade passages in a front face each connecting with a corresponding phase and neutral conductor to receive an electrical plug with a similar blade configuration;
an electrical plug having a plug housing, phase and neutral blades electrically coupled to second ends of the phase and neutral conductors;
a shield surrounding one or more of the phase and neutral conductors; and
a leakage current detector interrupter electrically coupled to the phase, neutral and shield to detect a leakage of current.

12. The electrical extension cord of claim 11, comprising:
a relay operated solenoid to operate contacts that disconnect electrical continuity between the first end and the second end of each of the phase and neutral conductors in response to a signal from the leakage current detector interrupter,
wherein the leakage current detector interrupter includes a reset lock-out switch to prevent resetting of the relay operated solenoid to reconnect the first and second ends of each of the phase and neutral conductors.

13. The electrical extension cord of claim 12, wherein the leakage current detector interrupter comprises:
a first latching device to latch the relay operated solenoid in response to detection of a leakage current between the shield at least one of the phase and neutral conductors; and
a second latching device to latch the relay operated solenoid in response to detection of a leakage current between the phase and neutral conductors.

14. The electrical extension cord of claim 13, wherein the first and second latching devices comprise silicon controlled rectifiers.
